(19) United States
(12) Patent Application Publication
(10) Pub. No.: US 2014/0202160 A1
(43) Pub. Date: Jul. 24, 2014

(54) GAS TURBINE SYSTEM WITH MANIFOLD

(71) Applicant: GENERAL ELECTRIC COMPANY, Schenectady, NY (US)

(72) Inventors: Bryan Wesley Romig, Greenville, SC (US); Brandon Taylor Overby, Greenville, SC (US)

(73) Assignee: GENERAL ELECTRIC COMPANY, Schenectady, NY (US)

(21) Appl. No.: 13/749,661

(22) Filed: Jan. 24, 2013

(51) Int. Cl. F02C 7/00

(52) U.S. Cl. CPC F02C 7/00
USPC 60/740; 60/805

(57) ABSTRACT

A system including a gas turbine engine, including a combustor configured to generate products of combustion, a turbine driven by the products of combustion from the combustor, a compressor having a compressor discharge leading into a chamber between the combustor and a compressor discharge casing, an extraction manifold coupled to the combustor, wherein the extraction manifold is fluidly coupled to the chamber.

### BACKGROUND

The subject matter disclosed herein relates to fluid injection systems, and more particularly to a manifold.

Various combustion systems include combustion chambers in which fuel and an oxidant, such as air, oxygen, and oxygen-containing mixtures, combust to generate hot gases. For example, a gas turbine engine may include one or more combustion chambers that are configured to receive compressed air from a compressor, inject fuel and, at times, other fluids into the compressed air, and generate hot combustion gases to drive one or more turbine stages. Each combustion chamber may include one or more nozzles, a combustion zone within a combustion liner, a flow sleeve surrounding the combustion liner, and a gas transition duct. Compressed air from the compressor flows to the combustion zone through a gap between the combustion liner and the flow sleeve. Unfortunately, inefficiencies may be created as the compressed air passes through the gap, thereby negatively effecting performance of the gas turbine engine.

### BRIEF DESCRIPTION

In one embodiment, a system including a gas turbine engine, including a combustor configured to generate products of combustion, a turbine driven by the products of combustion from the combustor, a compressor having a compressor discharge leading into a chamber between the combustor and a compressor discharge casing, an extraction manifold coupled to the combustor, wherein the extraction manifold is fluidly coupled to the chamber.

In another embodiment, a system including a turbine combustor casing having a wall and a flange, wherein the wall and the flange extend circumferentially about an interior space, and the flange comprises an extraction aperture configured to be in fluid communication with a compressor discharge, and an extraction manifold coupled to the flange over the extraction aperture, wherein the extraction manifold including a first portion having a first passage with a first axis, and a second portion having a second passage with a second axis, wherein the first and second axes are offset from one another by an offset distance, and the first and second axes are oriented crosswise to one another.

In another embodiment, a system including an extraction manifold, including a first portion having a first passage with a first axis, wherein the first portion has a mounting flange configured to mount to a turbine combustor in fluid communication with a compressor discharge, and a second portion having a second passage with a second axis, wherein the first and second axes are offset from one another by an offset distance, the first and second axes are oriented crosswise to one another, and the second passage comprises at least one flow guide configured to inhibit swirl of an extraction flow, straighten the extraction flow, or a combination thereof.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas-turbine system;

FIG. 2 is a cross-sectional side view of an embodiment of a combustor with a high-pressure-air-extraction manifold;

FIG. 3 is a perspective view of an embodiment of a combustor casing with a high-pressure-air-extraction manifold;

FIG. 4 is a perspective view of an embodiment of a combustor-aft casing;

FIG. 5 is a cross-sectional view of an embodiment of a high-pressure-air-extraction manifold along line 5-5 of FIG. 3;

FIG. 6 is a cross-sectional view of an embodiment of a high-pressure-air-extraction manifold along line 5-5 of FIG. 3; and

FIG. 7 is a cross-sectional view of an embodiment of a high-pressure-air-extraction manifold along line 5-5 of FIG. 3.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are generally directed towards a system for providing steady pressurized airflow to pilot and/or blank cartridges (i.e., nozzles) in the combustor, to improve combustion dynamics. More specifically, the disclosed embodiments are directed to a combustor-aft casing with a high-pressure-air-extraction manifold. The combustor-aft casing includes an aperture in fluid communication with a source of steady pressurized air in the gas-turbine system. Steady pressurized airflow is therefore able to travel through the combustor-aft casing and the air-extraction manifold to the pilot and/or blank cartridges. Moreover, the air-extraction manifold includes features that reduce airflow swirl, thereby reducing pressure losses. A reduction in pressure losses through the air-extraction manifold increases the pressure available for the pilot and/or blank cartridges, improving combustion dynamics. For example, the air-extraction manifold may include an interior surface capable of reducing airflow swirl. The interior surface may be rough, jagged, pentagonally shaped, among others, reducing the ability of the airflow to swirl through the air-extraction manifold. By further example, the interior surface may include one or more flow guides (e.g., grooves, protrusions, or flats), which inhibit swirl of the airflow and help guide the airflow along the longitudinal axis of the manifold.

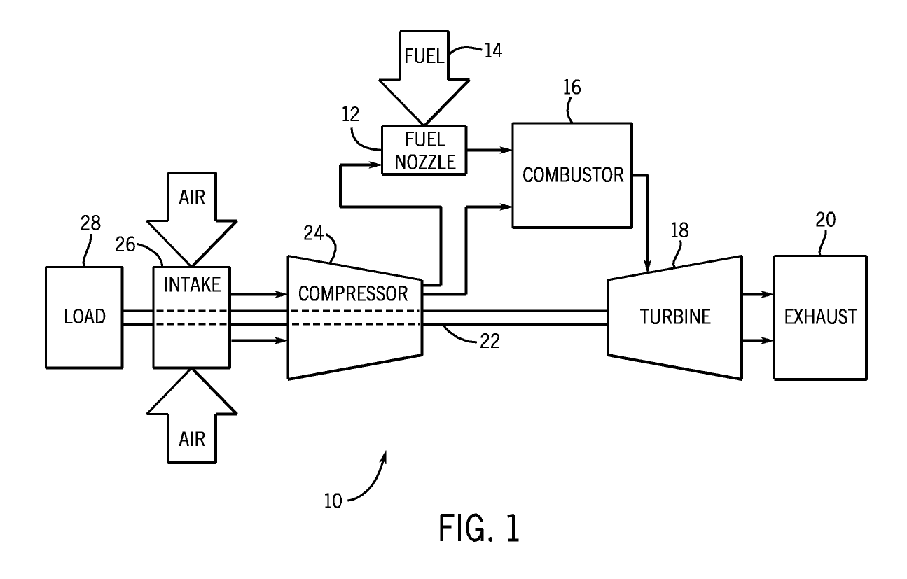

FIG. 1 is a block diagram of an embodiment of a turbine system 10. The turbine system 10 may use liquid or gas fuel, such as natural gas and/or a synthetic gas, to drive the turbine system 10. As depicted, one or more fuel nozzles 12 may intake a fuel supply 14, partially mix the fuel with air (e.g., an oxidant, such as O₂ and O₂ mixtures), and distribute the fuel and air mixture into the combustor 16 where further mixing occurs between the fuel and air. As described in the disclosed embodiments, a high-pressure-air-extraction manifold 64 couples to the combustor 16, guiding stable high-pressure air from the compressor to the fuel nozzle(s) 12. The stable high-pressure air enables purging of blank fuel nozzles/cartridges and/or to feed a pilot fuel nozzle/cartridge. The air-fuel mixture combusts in the combustor 16, thereby creating hot pressurized exhaust gases. The combustor 16 directs the exhaust gases through a turbine 18 toward an exhaust outlet 20. As the exhaust gases pass through the turbine 18, the gases force turbine blades to rotate a shaft 22 along an axis of the turbine system 10. As illustrated, the shaft 22 is connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of turbine system 10.

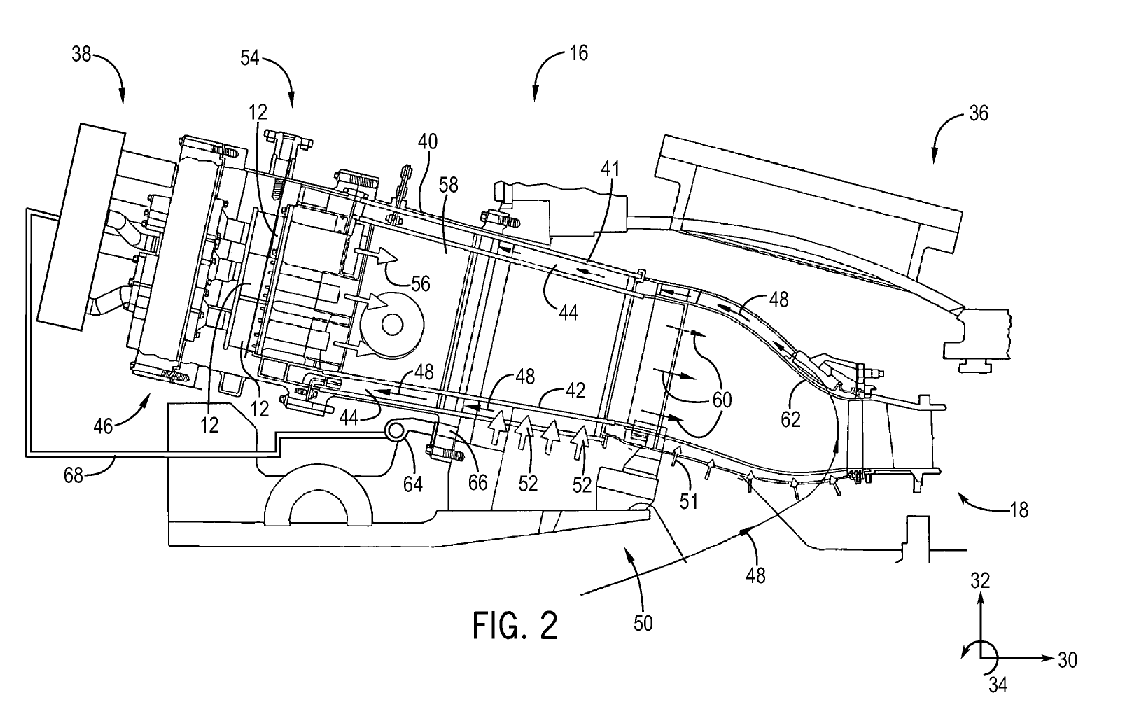

FIG. 2 is a cross-sectional side view of an embodiment of a combustor 16. As shown in FIG. 2, an axial axis 30 runs horizontally and is considered generally parallel to the shaft 22. A radial axis 32 runs vertically and is generally perpendicular to the shaft 22. Lastly, a circumferential direction 34 is considered to encircle the axial axis 30. The combustor 16 includes an aft end 36 and a fore end 38. The fore end 38 is located near the front (or upstream) of the turbine 18 and the aft end 36 is located near the back (or downstream) nearest the turbine 18. The radial outermost layer of the combustor 16 is the combustor-aft casing 40, which may enclose the components of the combustor 16. Portions of the combustor-aft casing 40 may be directly in contact with a flow sleeve 41, which aids in cooling the components of the combustor 16. Continuing inward in the radial direction 32, the next component is a combustion liner 42, which may contain the combustion reaction. An empty space is disposed between the flow sleeve 41 and the combustion liner 42, and may be referred to as an annulus 44. The annulus 44 may direct airflow to a head end 46 of the combustor 16. More specifically, airflow reaches the annulus 44 from compressed airflow discharged by the compressor 24 into the air plenum 50. The air plenum 50 surrounds the flow sleeve 41 enabling compressed air 48 to pass through apertures 52 and into the annulus 44. After passing through the apertures 52, the annulus 44 channels the compressed air 48 to the head end 46. In the head end 46, the compressed air 48 may be turned or redirected toward one or more fuel nozzles 12 (e.g., a set of fuel nozzles 54). The fuel nozzles 12 are configured to partially premix air and fuel to create a fuel air mixture 56. The fuel nozzles 54 discharge the fuel air mixture 56 into a combustion zone 58, where a combustion reaction takes place. The combustion reaction generates in hot pressurized combustion products 60. These combustion products 60 then travel through a transition piece 62 to the turbine 18, thereby generating mechanical power.

As explained above, the gas-turbine system 10 may include multiple fuel nozzles 12. The fuel nozzles 12 may include fuel cartridges, a pilot cartridge, and blank cartridges (e.g., cartridges that inject air but not fuel). The fuel cartridges combine fuel and air to create a fuel air mixture for combustion in the combustion zone 58. The pilot cartridge, like the fuel cartridges, combines fuel and air to create a fuel air mixture for combustion. However, the pilot cartridge anchors the combustion flame (i.e., affects combustion dynamics) for the remaining fuel cartridges. The blank cartridges, unlike the fuel and pilot cartridges, inject air into the combustion zone 58. Moreover, the blank cartridges, like the pilot cartridge, affect the combustion dynamics within the combustor 16. During operation, the air flowing through annulus 44 may not provide sufficiently stable airflow and pressure to the pilot cartridge and/or the blank cartridges. Accordingly, the gas-turbine system 10 includes a high-pressure-air-extraction manifold 64, which enables a steady flow of pressurized air to travel from the air plenum 50 directly to the fore end 38 of the combustor 16 for use in the pilot and/or blank cartridges. The pressure of the air inside the air plenum 50 is more stable and consistent than the airflow traveling through the annulus 44. Accordingly, the high-pressure extraction air manifold 64 facilitates combustion dynamics by channeling the steady supply of pressurized air in the air plenum 50 to the pilot and/or blank cartridges. As illustrated, the high-pressure-air-extraction manifold 64 couples to the combustor-aft casing 40 and is in fluid communication with the opening 66. The opening 66 enables airflow from the plenum 50 to travel through the manifold 64, through conduit or line 68, and into the head end 46 for use by the pilot and/or blank cartridges.

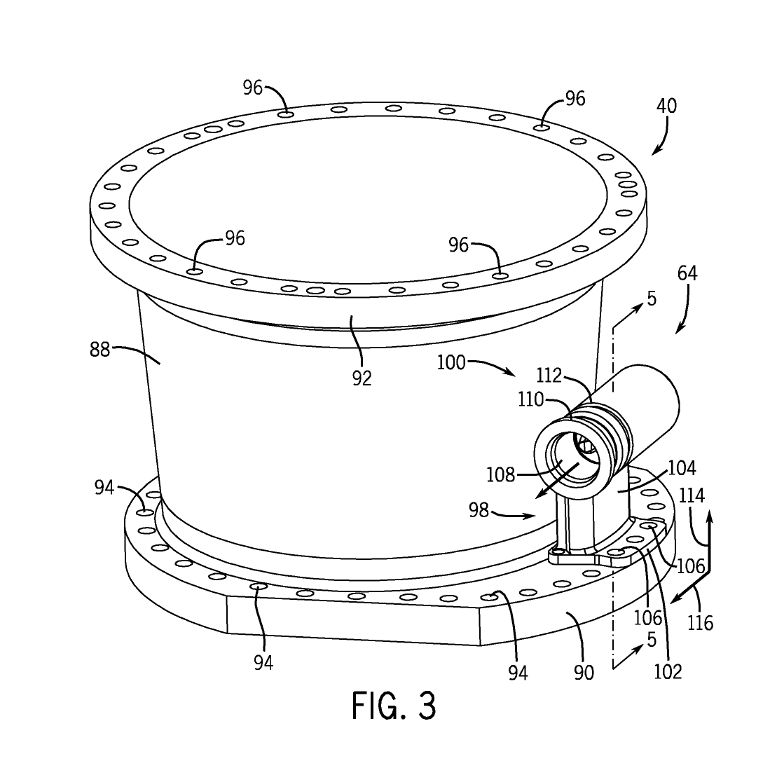

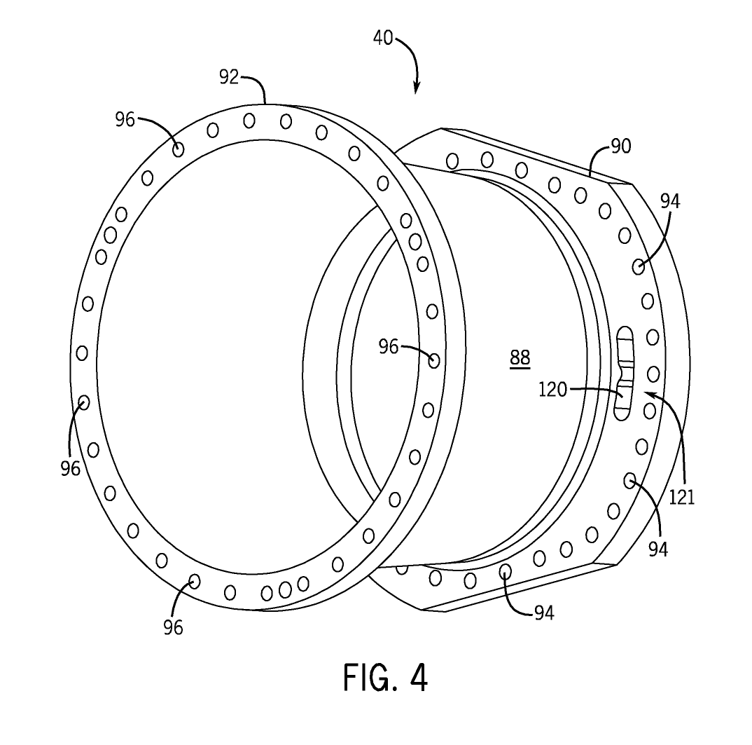

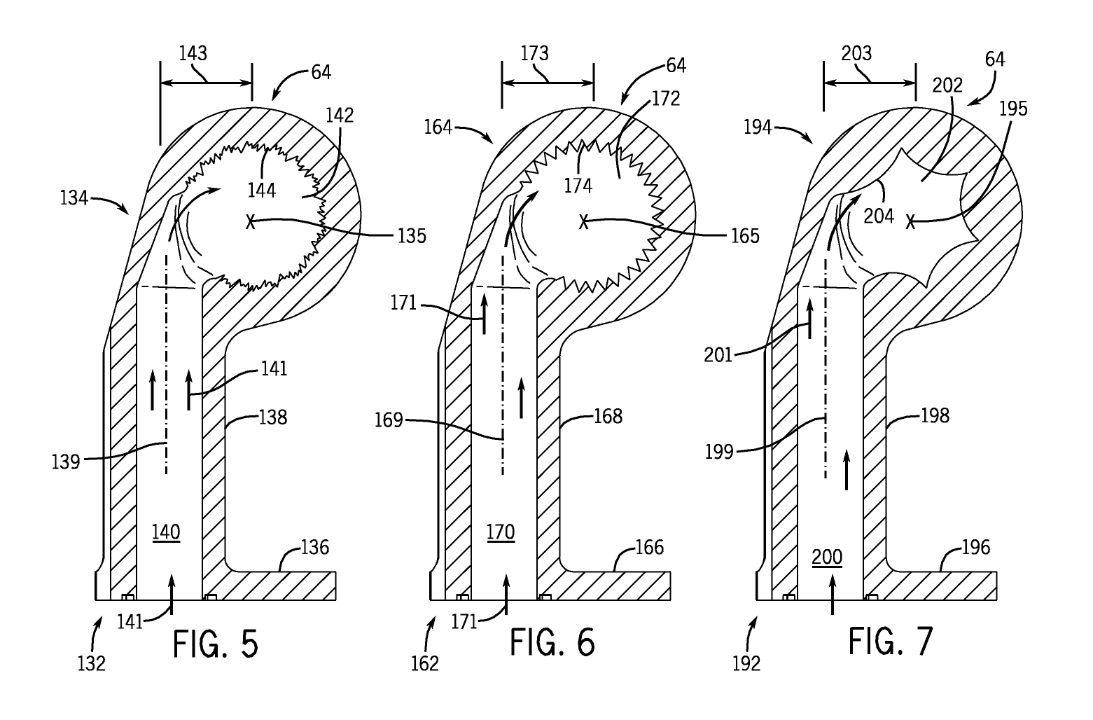

FIG. 3 is a perspective view of an embodiment of a combustor-aft casing 40 with the high-pressure-air-extraction manifold 64. As explained above, the combustor-aft casing 40 enables the high-pressure-air-extraction manifold 64 to channel a source of steady pressurized airflow from the air plenum 50 (seen in FIG. 2) to the pilot and/or blank cartridges. As illustrated, the combustor-aft casing 40 includes a casing wall 88, flange 90, and flange 92. The flanges 90 and 92 include respective apertures 94 and 96. The flanges 90 and 92 enable combustor-aft casing 40 to connect to the combustion flow sleeve 41 and to the head end 46 (seen in FIG. 2). Moreover, the apertures 94 enable the air-extraction manifold 64 to couple to the combustor-aft casing 40 with bolts, fasteners, etc. Specifically, the air-extraction manifold 64 couples to the flange 90 and over an air-extraction aperture (illustrated in FIG. 4). Accordingly, airflow is able to pass through the flange 90 and into the high-pressure-air-extraction manifold 64. The air-extraction manifold 64 includes a combustor-connection portion 98, and an air-line-connector portion 100. The combustor-connection portion 98 includes a flange 102 and a body portion 104. The combustor-connection portion 98 couples to the flange 90 with flange 102 using bolts that pass through apertures 106. The body portion 104 couples to the air-line-connector portion 100. Accordingly, as airflow passes through the flange 90 it enters the body portion 104, which then channels the airflow into the air-line-connector portion 100 for movement through line 68 (seen in FIG. 2). The air-line-connector portion 100 may be annular in shape and include an annular aperture 108 (e.g., bore or passage) and annular grooves 110 and 112. The annular grooves 110 and 112 enable connection of a line or hose 68 (e.g., an air conduit), for directing the steady pressurized air from the air plenum 50 to the head end 46 (seen in FIG. 2). In addition, the air-line-connector portion 100 may be offset from a conduit that runs through the combustor connector portion 98. Indeed, offsetting the air-line-connector portion 100 enables connection of the line or hose 68 without interference between the air-extraction manifold 64 and the combustor casing wall 88. As high-pressure airflow enters the air-extraction manifold 64 in direction 114, the airflow passes through the body portion 104 and into the aperture 108 of the air-line-connector portion 100. The pressurized airflow then exits the air-extraction manifold 64 in direction 116 into the line or hose 68 (seen in FIG. 2). Thus, airflow travels through the air-extraction manifold 64 in two directions that are generally crosswise (e.g., perpendicular) to one another. The change in direction of the airflow may induce swirling that may cause the airflow to lose pressure. As will be explained in more detail in FIGS. 5-7, the aperture 108 may include various anti-swirl surfaces that reduce swirling, and the associated pressure drops.

FIG. 4 is a perspective view of an embodiment of a combustor-aft casing 40 with an air-extraction aperture 120 at a mounting region 121 for the air-extraction manifold 64. The air-extraction aperture 120 enables the steady high-pressure air to travel from the air plenum 50 and into the air-extraction manifold 64 (seen in FIG. 2). Moreover, by including the aperture 120 in the flange 90, existing gas-turbine systems may be retrofitted with the air-extraction manifold 64. As illustrated, the flange 90 defines the air-extraction aperture 120. In the present embodiment, the aperture 120 forms a kidney bean shape (i.e., narrow opening between two large openings), enabling the aperture 120 to be adequately sized, but conform to the flange 90 (e.g., avoid interference with the apertures 94). In other embodiments, the aperture 120 may form different shapes to include rectangular, half-moon, elliptical, etc.

FIG. 5 is a cross-sectional view of an embodiment of a high-pressure-air-extraction manifold 64 taken along line 5-5 of FIG. 3. As explained above, the air-extraction manifold 64 enables pilot and blank cartridges to receive steady high pressure air from the air plenum 50 (seen in FIG. 2). In addition, the air-extraction manifold 64 reduces air pressure drops by blocking or inhibiting airflow swirl, thereby improving combustion dynamics with the pilot and/or blank cartridges. The air-extraction manifold 64 includes a combustor-connection portion 132 and an air-line-connector portion 134. The combustor-connection portion 132 includes a flange 136 and a body portion 138. As explained above, the flange 136 enables the air-extraction manifold 64 to couple to the combustor-aft casing 40 (seen in FIGS. 3 and 4). The body portion 138 includes a conduit 140 (i.e., a first passage). The conduit 140 conducts airflow 141 from the aperture 120 in the combustor-aft casing 40 (seen in FIG. 4), to the air-line-connector portion 134. As illustrated, the air-line-connector portion 134 includes an axis 135 (i.e., a first axis) and the body portion 138 includes an axis 139 (i.e., a second axis). The two axes 135 and 139 are offset from one another by a distance 143. The offset 143 between the two axes 135 and 139 may cause the airflow to swirl as the airflow 141 exits the conduit 140 and enters a conduit 142 (i.e., a second passage) of the air-line-connector portion 138. The swirling airflow causes pressure drops, thus reducing the air pressure available for the pilot and/or blank cartridges. As illustrated, the conduit 142 includes a rough interior surface 144. The rough interior surface 144 breaks up the airflow 141 (i.e., inhibiting swirl of the airflow 141) reducing the pressure drop of the airflow 141 through the air-extraction manifold 64. Thus, the disclosed embodiments include anti-swirl features on the interior surface of the conduit 142 to inhibit swirling flow of the airflow circumferentially about the first axis 135, while helping guide the airflow axially along the first axis 135 (i.e., the anti-swirl features may be described as flow guides, which extend in an axial direction along the first axis 135). Accordingly, the pilot and/or blank cartridges receive increased steady pressurized airflow from the air plenum 50 (seen in FIG. 2), improving combustion dynamics.

FIG. 6 is a cross-sectional view of an embodiment of a high-pressure-air-extraction manifold 64 taken along line 5-5 of FIG. 3. As explained above, the air-extraction manifold 64 enables pilot and blank cartridges to receive steady high pressure air from the air plenum 50 (seen in FIG. 2). Moreover, the air-extraction manifold 64 reduces airflow swirling and the associated pressure drops, thereby improving combustion dynamics with the pilot and/or blank cartridges. The air-extraction manifold 64 includes a combustor-connection portion 162 and an air-line-connector portion 164. The combustor-connection portion 162 includes a flange 166 and a body portion 168. As explained above, the flange 166 enables the air-extraction manifold 64 to couple to the combustor-aft casing 40 (seen in FIGS. 3 and 4). The body portion 168 includes a conduit 170 (i.e., a first passage). The conduit 170 enables airflow 171 to travel from the aperture 120 (seen in FIG. 4) in the combustor-aft casing 40 to the air-line-connector portion 164. As illustrated, the air-line-connector portion 164 includes an axis 165 (i.e., a first axis) and the body portion 168 includes an axis 169 (i.e., a second axis). The two axes 165 and 169 are offset from one another by a distance 173. The offset 173 between the two axes 165 and 169 may cause airflow entering a conduit 172 (i.e., a second passage) to swirl and lose pressure. As illustrated, the conduit 172 includes a jagged interior surface 174 (i.e., a surface that alternates between protrusions and grooves). The jagged interior surface 174 breaks up the airflow 171, enabling the airflow 171 to transition from the conduit 170 to the conduit 172 without swirling. More specifically, the jagged interior surface 174 reduces pressure losses by breaking up the swirling airflow 171. Thus, the disclosed embodiments include anti-swirl features on the interior surface of the conduit 172 to inhibit swirling flow of the airflow circumferentially about the first axis 165, while helping guide the airflow axially along the first axis 165 (i.e., the anti-swirl features may be described as flow guides, which extend in an axial direction along the first axis 165). Accordingly, the pilot and/or blank cartridges receive increased steady pressurized airflow from the air plenum 50 (seen in FIG. 2), improving combustion dynamics.

FIG. 7 is a cross-sectional view of an embodiment of a high-pressure-air-extraction manifold 64 along line 5-5. As explained above, the air-extraction manifold 64 enables pilot and blank cartridges to receive steady high pressure air from the air plenum 50 (seen in FIG. 2). Moreover, the air-extraction manifold 64 reduces swirling of the airflow and the associated pressure drops, enabling improved combustion dynamics with the pilot and/or blank cartridges. The air-extraction manifold 64 includes a combustor-connection portion 192 and an air-line-connector portion 194. The combustor-connection portion 192 includes a flange 196 and a body portion 198. As explained above, the flange 196 enables the air-extraction manifold 64 to couple to the combustor-aft casing 40 (seen in FIGS. 3 and 4). The body portion 198 includes a conduit 200 (i.e., a first passage). The conduit 200 enables airflow 201 to travel from the aperture 120 (seen in FIG. 4) in the combustor-aft casing 40 to the air-line-connector portion 194. As illustrated, the air-line-connector portion 194 includes an axis 195 (i.e., a first axis) and the body portion 198 includes an axis 199 (i.e., a second axis). The two axes 195 and 199 are offset from one another by a distance 203. The offset 203 between the two axes 195 and 199 may cause airflow entering a conduit 202 (i.e., a second passage) to swirl and lose pressure, reducing the air pressure available for the pilot and/or blank cartridges. As illustrated, the conduit 202 includes a pentagonal shaped interior surface 204. However, in other embodiments the interior surface may be any polygonal shape having 3, 4, 5, 6, 7, 8, 9, 10, or more sides (e.g., a triangle, square, rectangle, pentagon, hexagon, etc.). The pentagonal interior surface 204 breaks up the airflow 201, enabling the airflow 201 to transition from the conduit 200 to the conduit 202 without swirling. More specifically, the pentagonal interior surface 202 reduces pressure losses by breaking up the swirling airflow 201. Thus, the disclosed embodiments include anti-swirl features on the interior surface of the conduit 202 to inhibit swirling flow of the airflow circumferentially about the first axis 195, while helping guide the airflow axially along the first axis 195 (i.e., the anti-swirl features may be described as flow guides, which extend in an axial direction along the first axis 195). Accordingly, the pilot and/or blank cartridges receive increased steady pressurized airflow from the air plenum 50 (seen in FIG. 2), improving combustion dynamics.

Technical effects of the invention include a combustor-aft casing with an aperture, capable of receiving an air-extraction manifold. The aperture and air-extraction manifold enable steady compressed airflow to travel to the pilot and/or blank cartridges, enabling the pilot and/or blank cartridges to improve combustion dynamics in the gas-turbine system. Moreover, the air-extraction manifold includes swirl inhibiting features that reduce pressure losses. Accordingly, the air-extraction manifold increases the pressure available for the pilot and/or blank cartridges, improving combustion dynamics in the gas-turbine system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas turbine engine, comprising:
a combustor configured to generate products of combustion;
a turbine driven by the products of combustion from the combustor;
a compressor having a compressor discharge leading into a chamber between the combustor and a compressor discharge casing;
an extraction manifold coupled to the combustor, wherein the extraction manifold is fluidly coupled to the chamber.

2. The system of claim 1, wherein the combustor comprises a combustor casing having a flange, wherein an extraction path extends from the chamber, through the flange, and through the extraction manifold.

3. The system of claim 2, wherein the flange includes an aperture along the extraction path, and the aperture has a non-circular shape.

4. The system of claim 3, wherein the aperture has a central opening directly between and connected to lateral openings, and the lateral openings are enlarged relative to the central opening.

5. The system of claim 2, wherein the extraction manifold is coupled to the flange of the combustor over an aperture in the flange.

6. The system of claim 5, wherein the extraction manifold comprises a first portion having a first passage with a first axis and a second portion having a second passage with a second axis, wherein the first and second axes are offset from one another by an offset distance, and the first and second axes are oriented crosswise to one another.

7. The system of claim 5, wherein the first and second axes substantially perpendicular to one another.

8. The system of claim 6, wherein the extraction manifold comprises at least one flow guide configured to inhibit swirl of an extraction flow, straighten the extraction flow, or a combination thereof.

9. The system of claim 8, wherein the at least one flow guide is disposed along an interior surface of the second portion, and the at least one flow guide comprises a plurality of recesses, protrusions, flats, or a combination thereof.

10. The system of claim 1, wherein the extraction manifold comprises at least one flow guide configured to inhibit swirl of an extraction flow, straighten the extraction flow, or a combination thereof.

11. The system of claim 1, wherein the extraction manifold comprises a first portion having a first passage with a first axis and a second portion having a second passage with a second axis, wherein the first and second axes are offset from one another by an offset distance, and the first and second axes are oriented crosswise to one another.

12. A system, comprising:
a turbine combustor casing having a wall and a flange, wherein the wall and the flange extend circumferentially about an interior space, and the flange comprises an extraction aperture configured to be in fluid communication with a compressor discharge; and
an extraction manifold coupled to the flange over the extraction aperture, wherein the extraction manifold comprises:
a first portion having a first passage with a first axis; and
a second portion having a second passage with a second axis, wherein the first and second axes are offset from one another by an offset distance, and the first and second axes are oriented crosswise to one another.

13. The system of claim 12, wherein the extraction manifold comprises at least one flow guide configured to inhibit swirl of an extraction flow, straighten the extraction flow, or a combination thereof.

14. The system of claim 13, wherein the at least one flow guide is disposed in the second portion.

15. The system of claim 14, wherein the at least one flow guide comprises a plurality of recesses, protrusions, flats, or a combination thereof, each extending lengthwise along the second axis of the second passage.

16. The system of claim 14, wherein the at least one flow guide is disposed along an interior surface of the second passage, and the flow guide comprises a polygonal shape of the interior surface.

17. The system of claim 12, wherein the extraction aperture has a central opening directly between and connected to lateral openings, and the lateral openings are enlarged relative to the central opening.

18. The system of claim 12, comprising a turbine combustor having the turbine combustor casing, a fuel nozzle disposed in a head end of the turbine combustor, and a conduit between the extraction manifold and the head end of the turbine combustor, wherein the conduit is configured to direct an extraction flow into the head end, the fuel nozzle, or a combination thereof.

19. The system of claim 18, comprising a gas turbine engine having the turbine combustor.

20. A system, comprising:
an extraction manifold, comprising:
a first portion having a first passage with a first axis, wherein the first portion has a mounting flange configured to mount to a turbine combustor in fluid communication with a compressor discharge; and
a second portion having a second passage with a second axis, wherein the first and second axes are offset from one another by an offset distance, the first and second axes are oriented crosswise to one another, and the second passage comprises at least one flow guide configured to inhibit swirl of an extraction flow, straighten the extraction flow, or a combination thereof.
